(19) United States
(12) Patent Application Publication
(10) Pub. No.: US 2024/0003117 A1
(43) Pub. Date: Jan. 4, 2024

(54) POWERTRAIN FOR A WORKING MACHINE, METHOD FOR OPERATING THE POWERTRAIN AND WORKING MACHINE

(71) Applicant: ZF FRIEDRICHSHAFEN AG, Friedrichshafen (DE)

(72) Inventors: Migen Bebeti, Munich (DE); Rico Gloeckner, Pocking (DE)

(21) Appl. No.: 18/257,880

(22) PCT Filed: Dec. 8, 2021
(86) PCT No.: PCT/EP2021/084724

§ 371 Date: Jun. 16, 2023

(30) Foreign Application Priority Data
Dec. 18, 2020 (DE) 10 2020 216 269.7

(51) Int. Cl. E02F 9/20; B60L 50/60

(52) U.S. Cl. CPC E02F 9/207; B60L 50/60; B60L 2200/40

(57) ABSTRACT

A drivetrain for a working machine, including at least one electric motor and an electric energy storage device. The at least one electric motor is configured to provide mechanical power and the energy storage device is configured to supply the at least one electric motor with electrical power. The energy storage device includes at least two individual storage units electrically connected in series.

### CROSS REFERENCE TO RELATED APPLICATIONS

This application is a U.S. National Phase application under 35 U.S.C. § 371 of International Application No. PCT/EP2021/084724, filed on Dec. 8, 2021, and claims benefit to German Patent Application No. DE 10 2020 216 269.7, filed on Dec. 18, 2020. The International Application was published in German on Jun. 23, 2022 as WO 2022/128667 A1 under PCT Article 21(2).

### FIELD

The present invention relates to a drivetrain for a working machine, a method for operating a drivetrain of a working machine, and a corresponding working machine.

### BACKGROUND

In the prior art, electrically driven working machines, such as wheel loaders, skid-steer loaders, telescopic loaders, dumpers or even excavators, are known. These electrically driven working machines are either purely electrically driven, i.e. they exclusively have an electric battery and/or an accumulator for their energy supply, or they are diesel-electrically driven, which means that the required energy is provided by a diesel-driven generator, usually in conjunction with an electric buffer storage, such as an appropriately dimensioned capacitor. In all cases, the mechanical power required for the travel drive and the work drive is provided by one or more electric motors. Furthermore, hybrid-electric working machines are also known in which the mechanical power required for operation is provided primarily by an internal combustion engine, usually a diesel engine. An additionally provided electric motor is supplied by a battery and/or an accumulator and typically performs a so-called boost function.

In this context, DE 20 2014 000 738 U1 describes a wheel loader driven purely electromotively, which has a first electric motor for a travel drive and a second electric motor for a work drive.

Also known in the prior art are electrically driven passenger cars, for example from DE 10 2019 109 550 A1, DE 10 2013 102 161 A1 or DE 10 2010 020 576 A1.

The known electrically driven working machines have disadvantages compared to the known electrically driven passenger cars in that, on the one hand, they are produced in significantly lower quantities, which in turn significantly increases the cost per unit. In addition, because of the significantly higher mechanical power requirements compared to passenger cars, electrically driven working machines require a vehicle electrical system that is operated at higher voltages. However, a vehicle electrical system configured for higher operating voltages in turn increases its costs. As a result, electrically driven working machines are significantly more expensive than electrically driven passenger cars.

### SUMMARY

In an embodiment, the present disclosure provides a drivetrain for a working machine, comprising at least one electric motor and an electric energy storage device. The at least one electric motor is configured to provide mechanical power and the energy storage device is configured to supply the at least one electric motor with electrical power. The energy storage device comprises at least two individual storage units electrically connected in series.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates a working machine according to an embodiment of the invention; and

FIG. 2 illustrates a method according to an embodiment of the invention for operating a drivetrain of a working machine in the form of a flow chart.

### DETAILED DESCRIPTION

In an embodiment of the invention, an improved drivetrain for a working machine is provided.

In an embodiment, the invention relates to a drivetrain for a working machine, comprising at least one electric motor and one electric energy storage device, wherein the at least one electric motor is configured to provide a mechanical power and wherein the energy storage device is configured to supply the at least one electric motor with electrical power. The drivetrain according to an embodiment of the invention is characterized in that the energy storage device comprises at least two individual storage units connected electrically in series.

An embodiment of the invention thus describes a drivetrain suitable for driving a working machine. Since working machines generally operate under high drive loads and, in particular, also produce comparatively high work outputs in absolute terms, the drivetrain according to an embodiments of the invention differs, for example, from a passenger car drivetrain, which is typically operated in a load range of 5% to 10% of the maximum output and, in particular, produces lower mechanical outputs in absolute terms by comparison.

The drivetrain comprises thereby at least one electric motor. Since a working machine usually requires at least one work drive in addition to a travel drive, the at least one electric motor can be assigned equally to the travel drive and the at least one work drive.

Preferably, however, the drivetrain comprises two or more electric motors, of which at least one electric motor is assigned to the travel drive and at least one other electric motor is assigned to the work drive.

Alternatively, the two or more electric motors can drive a summation gearbox, for example, and an output of the summation gearbox can drive both the travel drive and the work drive.

The at least one electric motor is preferably an asynchronous motor.

The at least one electric motor is configured to provide a mechanical power. The mechanical power is advantageously provided via a motor shaft of the at least one electric motor and can subsequently be subjected to a speed and torque conversion, for example via a gearbox or a transmission stage. The mechanical power is then made available to the travel drive and/or the work drive.

The transmission is preferably configured as a multi-stage manual transmission, in particular a synchronous transmission, which converts a mechanical input power provided by the at least one electric motor with regard to its speed and torque in accordance with a selected stage. Although electric motors have a comparatively large speed range of zero to approx. 20,000 rpm compared to internal combustion engines, a comparatively high resulting torque can be generated by using a manual transmission and a corresponding speed ratio, which is of great advantage for the operation of a working machine, since heavy work can also be performed in this way.

Advantageously this can be a powershift manual transmission.

Furthermore, the drivetrain comprises an electric energy storage device, which is preferably configured as a rechargeable Li-ion battery. The energy storage device stores an electrical energy that can be made available for the operation of the at least one electric motor in order to supply the at least one electric motor with the respectively required electrical power. In particular, the electrical energy can also be made available for the operation of further electrical consumers, such as pumps, valves, computing units, air conditioning devices of the driver's cab, displays, lights and/or headlights.

According to an embodiment of the invention, it is thus provided that the energy storage device comprises at least two individual storage units electrically connected in series. This results in the advantage that two or more comparatively cost-efficient, electrical, individual energy storage units can be used in series, each of which can provide only a portion, for example the 1/n part, of the operating voltage required for the operation of the comparatively powerful working machine, wherein n is the total number of the individual storage units connected in series. Due to the series connection, the individual voltages of the individual storage units add up so that in total the required operating voltage is available. Preferably, it is provided that the at least two individual storage units are each designed to supply a passenger car drivetrain with electrical power. Since such individual storage units for operating electric passenger car drivetrains are produced in much larger numbers than energy storage devices for electric working machines, they are correspondingly more cost-effective due to the so-called production quantity effect.

By using two or more individual storage units according to embodiments the invention, in particular from the passenger car sector, the costs for manufacturing a battery-electrically operated drivetrain of a working machine can be thus noticeably reduced without any disadvantages in terms of performance or operating time of the working machine.

In addition to the connection in series of two or more individual storage units to increase the operating voltage, it is advantageously provided that two or more individual storage units are connected in parallel in order to increase the electrical capacity.

According to a preferred embodiment of the invention, it is provided that the drivetrain is designed to charge the at least two individual storage units each separately with electrical energy by means of an external charging device, i.e. that each individual storage unit can be charged individually and independently of the other individual storage unit or units. Thus, for example, it is possible to resort to the passenger car charging stations already available in comparatively large numbers, in particular from the passenger car fast-charging network, in order to charge the individual storage units. Furthermore, the charging process is also shortened by about half of the charging time that would otherwise be necessary, since all the individual storage units can be charged in parallel and each with the maximum possible electric current.

According to a preferred embodiment of the invention, it is provided that the drivetrain is configured to use at least one of the at least two individual storage units to supply the at least one electric motor with electrical power and, at the same time, to charge at least one further one of the at least two individual storage units with electrical energy by means of the external charging device. This results in the advantage that the working machine can continue to be operated via at least one individual storage unit, for example in a stationary mode, i.e. that the work drive of the working machine can be operated via at least one individual storage unit while at least one further individual storage unit is being charged. However, since in this state the full number of individual storage units is not available for operating the working machine, only comparatively low power-intensive work can be performed.

According to a preferred embodiment of the invention, it is provided that all electric motors are arranged in a common housing. This enables a space- and weight-saving arrangement of all electric motors within the drivetrain in a working machine. In addition, the common housing compared to two or more individual housings saves weight and costs. For example, two electric motors can be built axially in series in a common housing, with the motor shafts, for example, pointing in opposite axial directions out of the housing. Likewise, however, an arrangement of several electric motors axially parallel in an appropriately designed housing is also possible and preferred, so that all motor shafts, for example, can point in the same axial direction.

An embodiment of the invention further relates to a method for operating a drivetrain for a working machine, wherein the drivetrain comprises at least one electric motor and an electric energy storage device, wherein mechanical power is provided by the at least one electric motor and wherein the at least one electric motor is supplied with electrical power by the energy storage device. The method according to an embodiment of the invention is characterized in that the electrical power is provided by at least two individual storage units connected electrically in series, which together constitute the energy storage device. This results in the advantages already described in connection with the drivetrain according to embodiments of the invention.

According to a preferred embodiment of the invention, it is provided that the at least two individual storage units are each separately charged with electrical energy by means of an external charging device.

According to a preferred embodiment of the invention, it is provided that the at least one electric motor is supplied with electrical power from at least one of the at least two individual storage units and, simultaneously, at least one further one of the at least two individual storage units is charged with electrical energy by means of the external charging device.

An embodiment of the invention further relates to a working machine comprising a drivetrain according to the invention. From this, the advantages already described in connection with the drivetrain according to embodiments of the invention also result for the working machine according to embodiments of the invention.

Preferably, it is provided that the working machine is configured as a wheel loader, dumper, excavator, telescopic loader, public utility vehicle, garbage collection vehicle, mining vehicle, skid-steer loader, aircraft tractor or tractor.

Embodiments of the invention are explained below by way of examples of embodiments shown in the figures. These show:

Identical objects, functional units and comparable components are designated with the same reference numerals across all figures. These objects, functional units and comparable components are identical in terms of their technical features unless the description explicitly or implicitly states otherwise.

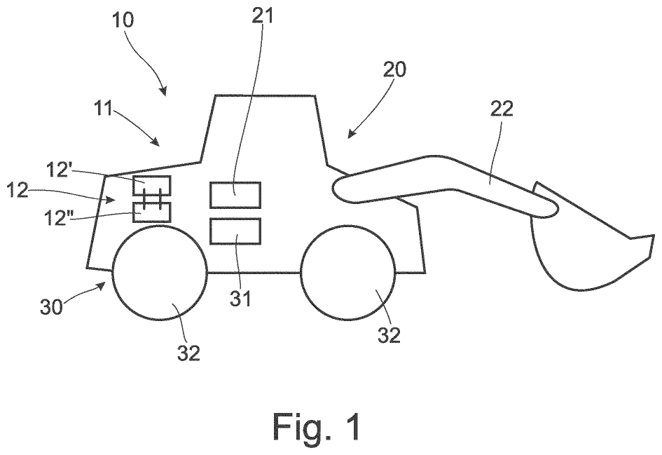

FIG. 1 shows exemplarily and schematically a possible embodiment of a working machine 10 according to an embodiment of the invention. The working machine 10 is designed exemplarily as a wheel loader 10 and comprises an electric drivetrain 11. The electric drivetrain 11 in turn comprises a work drive 20 with a first electric motor 21 and a work device 22, a travel drive 30 with a second electric motor 31 and driven vehicle wheels 32 as well as an electric energy storage device 12. The first electric motor 21 is designed to provide a first mechanical power for operating the work drive 20 and to actuate the work device 22. The second electric motor 31 is configured to provide a second mechanical power for the operation of the travel drive 30 and to generate propulsion at the vehicle wheels 32 in a direction desired by the operator of the working machine 10. Further, the drivetrain 11 includes an energy storage device 12 configured to provide electrical power to the first and second electric motors 21, 31. Since the drivetrain 11 is configured to drive the working machine 10 and working machines generally operate under high drive loads and, in particular, also produce comparatively high work outputs in absolute terms, the drivetrain 11 according to an embodiment of the invention differs, for example, from a passenger car drivetrain, which is typically operated in a load range of 5% to 10% of the maximum output and, in particular, produces lower work outputs in absolute terms. Accordingly, the energy storage device 12 must also provide a comparatively higher operating voltage than, for example, an energy storage device of an electrically powered passenger car drivetrain. However, since the purchase costs of such high-performance energy storage devices are many times higher than those of energy storage devices of an electrically powered passenger car drivetrain, the energy storage device 12 consists, for example, of two individual storage units 12′, 12″ electrically connected in series. The individual storage units 12′, 12″ are, for example, two individual storage units 12′, 12″, each of which is configured to individually supply a passenger car drivetrain with electrical power. Thus, the required performance of the energy storage device 12 can be provided at significantly lower costs. A further advantage resulting from the composition of the energy storage device 12 of two individual storage units 12′, 12″ is that the two individual storage units 12′, 12″ can each be charged separately with electrical energy by means of an external charging device, which significantly reduces the overall duration of the charging process.

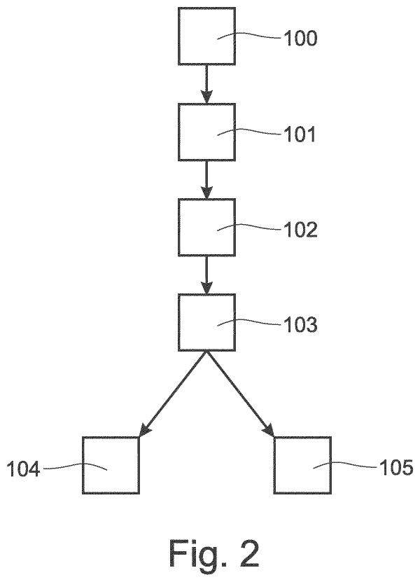

FIG. 2 shows exemplarily and schematically a possible embodiment of a method according to the invention for operating a drivetrain 11 of a working machine 10 in the form of a flow chart. The drivetrain 10 comprises at least one electric motor 21, 31 and an electric energy storage device 12. The energy storage device 12, exemplarily comprises, at least two individual storage units 12′, 12″ electrically connected in series, which together constitute the energy storage device 12. In a first method step 100, a mechanical power is demanded from the at least one electric motor 21, 31. Thereupon, in method step 101, the at least one electric motor 21, 31 is supplied with electrical power from the energy storage device 12. Since the energy storage device 12 comprises at least two individual storage units 12′, 12″ connected electrically in series, the electrical power is provided by all the individual storage devices 12′, 12″ essentially equally proportionally. In step 102, the at least one electric motor 21, 31 converts the electrical power into a mechanical power, so that the at least one electric motor 21, 31 can now provide the requested mechanical power. In the following method step 103, it is, for example, determined that the energy storage device 12 has a state of charge of less than 50%. Thereupon, in method step 104, the working machine 10 in stationary mode is operated with reduced electrical power, whereby a first portion of the individual energy storage units 12′, 12″ can be charged with electrical power via an external charging device in step 104, while at the same time, in step 105, a second portion of the individual energy storage units 12′, 12″ continues to supply the at least one electric motor 21, 31 with electrical power.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

working machine, wheel loader
11 drivetrain
12 electric energy storage device
12′, 12″ single storage units
20 work drive
21 electric motor
22 work device
30 travel drive
31 electric motor
32 vehicle wheel
100 demanding of a mechanical power
101 supplying of at least one electric motor with electrical power from the energy storage device
102 providing of the mechanical power
103 determining of the state of charge
104 loading of a single storage unit
105 supplying of at least one electric motor with electrical power from a single storage unit

1. A drivetrain for a working machine, comprising:
at least one electric motor; and
an electric energy storage device,
wherein the at least one electric motor is configured to provide mechanical power,
wherein the energy storage device is configured to supply the at least one electric motor with electrical power, and
wherein the energy storage device comprises at least two individual storage units electrically connected in series.

2. The drivetrain according to claim 1, wherein the energy storage device further comprises at least two individual storage units electrically connected in parallel.

3. The drivetrain according to claim 1, wherein the at least two individual storage units are each configured to individually supply a passenger car drivetrain with electrical power.

4. The drivetrain according to claim 1, wherein the drivetrain is configured to charge each of the at least two individual storage units separately with electrical energy by an external charger.

5. The drivetrain according to claim 4, wherein the drivetrain is configured to use at least one of the at least two individual storage units to supply the at least one electric motor with electrical power, and simultaneously charge at least one further one of the at least two individual storage units with electrical energy by the external charger.

6. The drivetrain according to claim 1, wherein the drivetrain comprises at least two electric motors, of which at least one electric motor is assigned to a travel drive of the working machine and at least one further electric motor is assigned to a work drive of the working machine.

7. The drivetrain according to claim 1, each of the at least one electric motors is arranged in a common housing.

8. A method of operating a drivetrain for a working machine, wherein the drivetrain comprises at least one electric motor and one electric energy storage device, the method comprising:
providing mechanical power by the at least one electric motor, and
supplying the at least one electric motor with electrical power from the energy storage device,
wherein the electrical power is provided by at least two individual storage units connected electrically in series, which together form at least part of the energy storage device.

9. The method according to claim 8, further comprising charging each of the at least two individual storage units separately with electrical energy by an external charger.

10. The method according to claim 8, further comprising supplying the at least one electric motor with electrical power from at least one of the at least two individual storage units, and simultaneously charging at least one further one of the at least two individual storage units with electrical energy by the external charging device.

11. A working machine comprising the drivetrain according to claim 1.

12. The method according to claim 9, further comprising supplying the at least one electric motor with electrical power from at least one of the at least two individual storage units, and simultaneously charging at least one further one of the at least two individual storage units with electrical energy by the external charging device.
